(19) United States
(12) Patent Application Publication
(10) Pub. No.: US 2023/0018484 A1
(43) Pub. Date: Jan. 19, 2023

(54) A VARIABLE COLLAPSIBLE PEN ESPECIALLY FOR DOGS

(71) Applicant: Vlasta BREZINOVÁ, Jicin (CZ)

(72) Inventor: Vlasta BREZINOVÁ, Jicin (CZ)

(21) Appl. No.: 17/782,994

(22) PCT Filed: Dec. 7, 2020
(86) PCT No.: PCT/CZ2020/050093

§ 371 Date: Jun. 7, 2022

(30) Foreign Application Priority Data
Dec. 9, 2019 (CZ) PV 2019-760

(51) Int. Cl. A01K 1/03

(52) U.S. Cl. CPC A01K 1/034

(57) ABSTRACT

A variable collapsible pen especially for dogs comprises at least n rear frames made of corrosion-resistant material, where n is greater than or equal to 1, provided with a back and formed by stems of corrosion-resistant material interconnected by crossbeams of corrosion-resistant material. Each rear frame (1) comprises two stems, the n-th stem (1.1.n) fitted with a foot (1.4) at the bottom with anchoring holes and the (n+1)-th stem (1.1.n+1) fitted with a foot (1.4) at the bottom with anchoring holes, interconnected at lest with the top crossbeam (1.2), center crossbeam (1.16) and bottom crossbeam (1.3) wherein the first stem (1.1.1) is provided in its bottom half under the level of the center crossbeam (1.16) at least on one side with three hinges (1.8) for the outer side panel, with which it is connected to the outer side panel frame (2.1), filled with an opaque panel (2.9), and provided from its inner side in its bottom third with a horizontal flat bar (2.3) affixed to the outer side panel frame (2.1) provided with the counterpart (2.10) of the locking mechanism, the center crossbeam (1.16) is provided with at least two roof hinges (1.7), with which it is connected to the roof frame (5.1) with a roof panel (5.6), provided with at least two locks (5.5) against unintentional folding of the canopy, and at least two first mounts (5.9) of the roof spring (1.10) that are connected through the roof spring (1.10) with the second mounts (1.9) of the roof spring (1.10) in the top part of the stem, the top crossbeam (1.2) is provided with two counterparts (1.6.1) of the lock against unintentional folding of the canopy (5) and the second up to the (n+1)-th stems (1.1.2 to 1.1.n) are provided in their bottom half under the level of the center crossbeam (1.16) at least on one side with three hinges (1.15) for the inner side panel, with which it is connected to the (n-1)-th side panel frame (2.1.1), provided with a lock (1.6) against unintentional opening having an opaque panel (2.9) and which is connected via door hinges (4.7) with the door frame (4.1) with a transparent perforated door panel (4.6) and provided with a locking mechanism (4.3), and the second up to the n-th inner side panels are provided from the outer side with a horizontal flat bar (2.3) affixed to the inner side panel frame (2.1) and provided with the counterpart (2.10) of the locking mechanism.

### TECHNICAL FIELD

The variable folding pen can be easily folded and unfolded and is designed especially for short-term placement of one or more dogs in public.

### BACKGROUND ART

Keeping dogs is very widespread, dogs have accompanied humans since time immemorial. However, with the development of cities and large shopping centers in recent years, there is an increasing problem where to put the dog during a visit, for example at the store. Due to lack of other solutions, dogs tend to be tied, for example, to bicycle stands, which does not suit the dogs, and in addition, conflicts arise.

There are already various solutions available abroad. They are however expensive and have other shortcomings that prevent their expansion. For example, US2016262343 discloses an animal storage pen solution with automated access and payment with verified user identification and verified animal identification associated with animal vaccination and medical records. The pen is designated for the interior, it is not foldable, its high purchase price and operating costs are reflected in the price for the use of the pen by customers, as a result of which it is not widespread and used. In addition, it has mesh sides, and with more adjacent pens it is disadvantageous, because dogs can see each other.

Furthermore, various closed sheds are known, which may lack a natural air flow, provided with a fan or air conditioning. Such a device is disclosed for example by the document US2017027131. It is controlled by a software system and is equipped with a communication system for external control. The pen allows for monitoring of the pet and has a number of comfortable elements. It can be remotely controlled using a mobile application that communicates with the pen and can be used to access and control the pen. Despite being furnished with all the smart technologies, such devices are not suitable for dogs, as they create an environment for serious respiratory diseases, eye inflammation and possible acceleration of the spread of introduced diseases. An entirely enclosed space may induce stress in some dogs. Such solutions place high demand on maintaining hygiene, this increases the possibility of infections, parasites, etc.

Furthermore, document CZ 269216 discloses a portable shed for breeding calves. It is an open shed with a small yard. The solution is not usable for use in public, does not correspond to short-term placement of the dog, no security for the dog or the surroundings is ensured.

Document AU 2015218420 discloses a solution for a portable folding pen for animals, which is intended for personal use, for securing one's own dog, e.g. in a car, in a cottage, in a hotel, etc. Due to the possibility of theft of the container and the dog, it cannot be used in public spaces. Similarly, various portable cages are available on the market, designed for the personal needs of the owner for one dog, which are only suitable for indoor use or travel. Additionally, these are not robust and may catch the claws, the animal cannot be left without supervision for a longer time.

Document CZ 14144 relates to modular pens or aviaries, consisting of interconnected panels. The assembly and disassembly of the pen is complex, and it obstructs the space after assembly.

Also, roofless collapsible mobile pens on wheels are also known, designed for roofed spaces such as halls, barns. They are difficult to assemble for the general public, tools are required. Wheels are required for assembly and disassembly, as the pen is high and heavy and therefore cannot be firmly anchored.

The “parking spaces” for dogs abroad are the result of the effort for maximum simplification and cost reduction, these, however, only delimit the space for the dog at the store. This area is marked by an elevated podium, where the dog is only tied with the possibility of access to water, where a sick dog could have drunk, there is absolutely no security for both the dog and passing customers, there is no security for the dog against theft, the possibility of hygiene on the artificial turf covering the podium is not easy, there is easy contact with other dogs, not only the tied ones (barking at each other) but also free-running ones.

### SUMMARY OF INVENTION

The variable collapsible pen especially for dogs according to the invention, comprises at least n rear frames made of corrosion-resistant material, where n is greater than or equal to 1, provided with a back and formed by stems of corrosion-resistant material interconnected by crossbeams of corrosion-resistant material. Each rear frame comprises two stems, the n-th stem fitted with a foot at the bottom with anchoring holes and the (n+1)-th one fitted with a foot at the bottom with anchoring holes, interconnected at least with the top crossbeam, center crossbeam and bottom crossbeam.

The first stem is provided in its bottom half under the level of the center crossbeam at least on one side with three hinges for the outer side panel, with which it is connected to the side panel frame, filled with an opaque panel provided in its bottom third with a horizontal flat bar affixed to the side panel frame provide with the counterpart of the locking mechanism.

The center crossbeam is provided with at least two roof hinges with which it is connected to the roof frame with roof panel, provided with at least two locks against unintentional folding of the canopy, and at least two first mounts of the roof spring which are connected via the roof spring with the second mounts of the roof spring in the top part of the stem.

The top crossbeam is provided with at least two counterparts of the lock against unintentional folding of the canopy.

The second up to the (n+1)-th stems are provided in their bottom half under the level of the center crossbeam at least on one side with three hinges for the outer side panel, with which it is connected to the (n-1)-th side panel frame, provided with a lock against unintentional opening having an opaque panel and which is connected via door hinges with the door frame with a transparent perforated door panel and provided with a locking mechanism,

The second up to the n-th inner side panels are provided from the outer side with a horizontal flat bar affixed to the inner side panel frame and provided with the counterpart of the locking mechanism.

In another variant, the stems are provided with holes for attachment to the wall, which also forms the back.

In a preferred embodiment, the door frame is provided with a collapsible handle and the inner side frame is provided on the outside with a collapsible side handle.

The perforation of the transparent breathable door panel is preferably implemented by circular ventilation holes with a diameter of 2 cm. Ventilation with the above embodiment is efficient and at the same time safe for dogs.

In another preferred embodiment, the inner side panel frame, the outer panel frame, and the bottom door on the side away from the rear frame are provided with a castor wheel.

In a preferred embodiment, the horizontal flat bar is provided with mounts for a chain with a snap-ring for small dogs and for a chain with a snap-ring for medium dogs.

The canopy is preferably provided with an elastic rope with a ring fixed in the middle for attachment to the rope mount located on the outside of the door panel and fixed with two mounts.

In another preferred embodiment, the stem is provided in its bottom half under the level of the center crossbeam on both sides with at least three hinges for the outer side panel, with which it is connected to the side panel frame, and the second up to (n+1)-th stems are provided in their bottom half under the level of the center crossbeam on both sides with at least three hinges for the inner side panel, with which it is connected to the (n-1)-th inner side panel frame.

The bottom crossbeam is preferably provided on at least one side with one mount of a chain with snap-ring, and a snap-ring mount.

The roof overlapping the pen is preferably fixed to the stems from above. The roof may be additionally supported by pillars provided with holders for accessories selected from the group of wastebaskets, bags, disposable absorbent floor mats, disposable gloves, disposable cleaning disinfectant wipes, treats, toys, disposable bowls, water barrels.

The space next to the pen under the overhanging roof can be equipped with a bench and/or a table.

The canopy and/or roof are preferably provided with a camera system from the inner side.

The roof and/or canopy are preferably provided with a solar panel for electrical system selected from the group of: lighting, heating, locking, audio guide.

In a preferable embodiment, the outer side panel frame is provided with a fixed handle on the outer side. In the most preferred embodiment, the outer side panel frame is provided with a lock against unintentional opening, and the inner side panel frame is provided with a lock against unintentional opening. The locks against unintentional opening are preferably provided with magnets.

Preferably, the inner side panel hinge and the outer side panel hinge have the angle of opening of 90°, and the door hinge and the roof hinge have the angle of opening of 180°.

The floor in the space for unfolding the pen is preferably provided with an impact rubber plate.

The transparent and clear panels may be preferably made of materials selected from the group of clear plexiglass, tinted plexiglass, polycarbonate with a UV film.

The opaque panels are preferably washable and are selected from the group of plastic, recycled plastic.

In the most preferred embodiment, the variable collapsible pen especially for dogs is treated with a disinfectant coating. Such coating, for example, contains silver particles.

The advantage of the solution according to the present invention is variability. In the first variant, the variable collapsible pen is attached to a wall, in the second, spatial variant, it can be placed freely in the space. In the third variant, the variable collapsible pen is placed in an already existing interior space, wherein this variant can also be used without a roof For all variants, it is important to observe a firm attachment to the ground.

The device may be designated for a single dog, and it can house multiple dogs according to the respective number of boxes. The pen can be folded and unfolded and it is designated especially for a short-term placement of dogs in public. It provides safety for the dog and the passers-by. Unfolding and folding is easy for everyone, so it can be self-service. When folded on a wall it does not obstruct the space, in the case of the roofed variant it serves as protection of persons against bad weather.

The pen has a natural air flow even with a full roofing with bad weather, it does not act as a closed space on the dog, and at the same time it is designed for more dogs so that they do not see each other, and mutual contact between dogs is also prevented. The maintenance of hygiene in it is simple, there is no possibility of infectious and polluted environment, it can be locked and thus secure the dog. Easy and hygienic watering of dogs is provided with disposable bowls, or with an own water barrel if running water is not available. The variant provided with a roof against bad weather protects both dogs and people from rain.

The variable collapsible pen also increases the level of public services provided, as well as, for example, urban furniture or shopping center equipment: installation of wastebaskets, bicycle stands, benches, shelters at bus stops or covered places for shopping trolleys, etc.

### BRIEF DESCRIPTION OF DRAWINGS

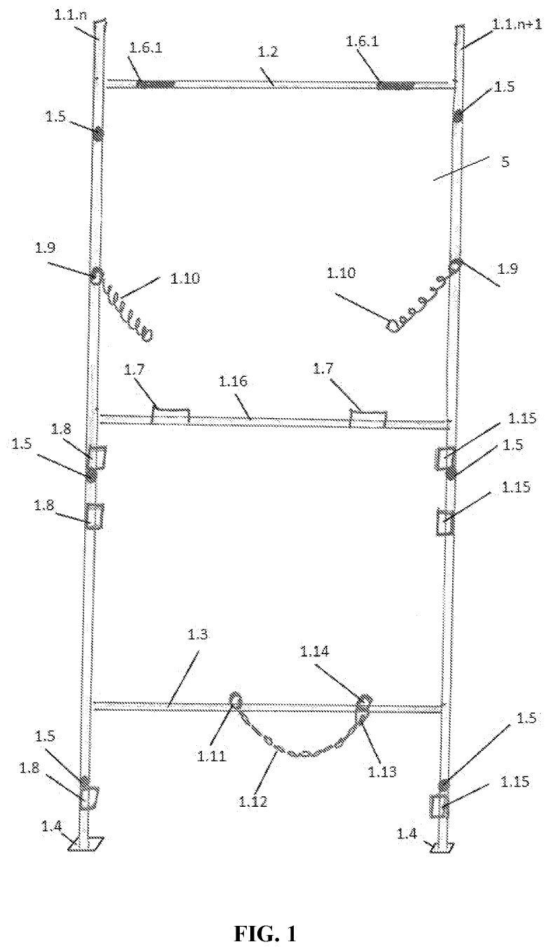

### FIG. 1

[FIG. 1] represent a detail of the frame,

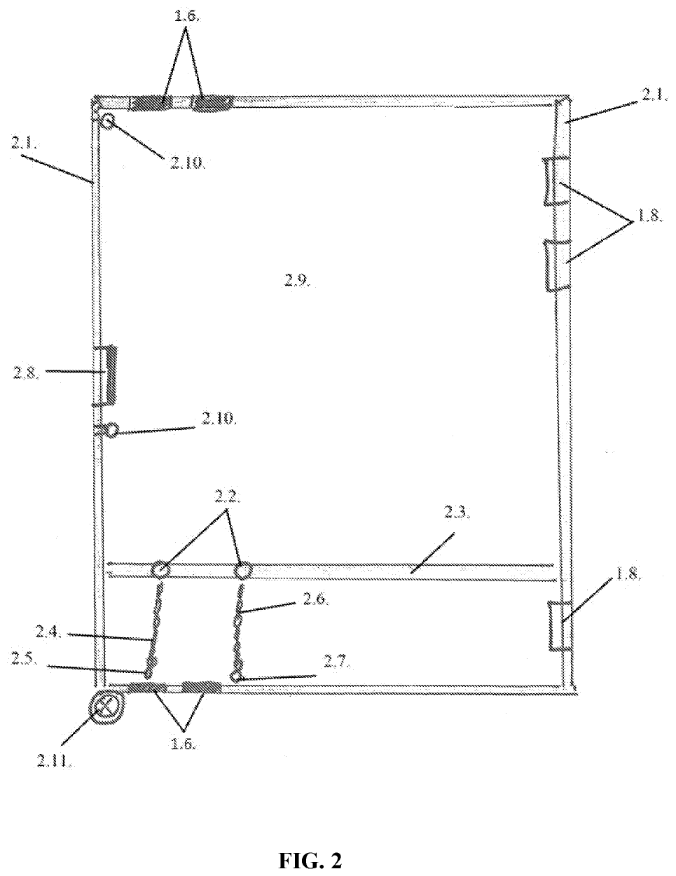

### FIG. 2

[FIG. 2] represent detail of the outer side panel,

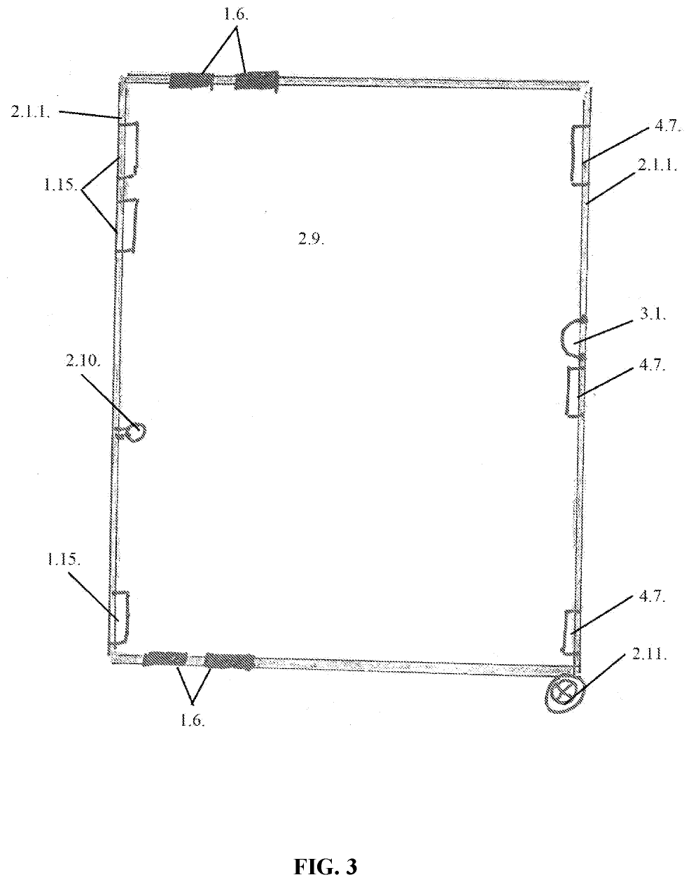

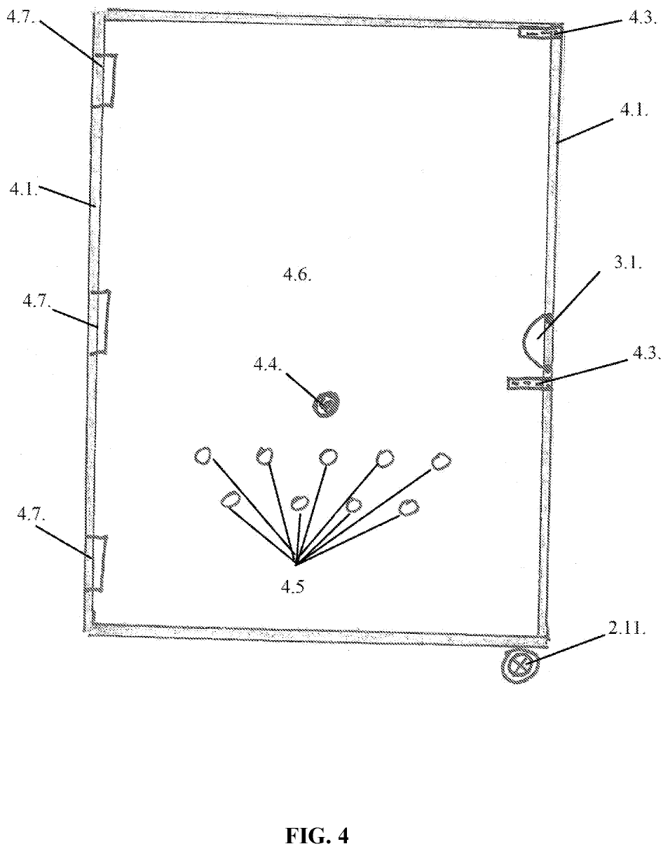

### FIG. 3

[FIG. 3] represent a detail of the inner side panel,

### FIG. 4

[FIG. 4] represent a detail of the door,

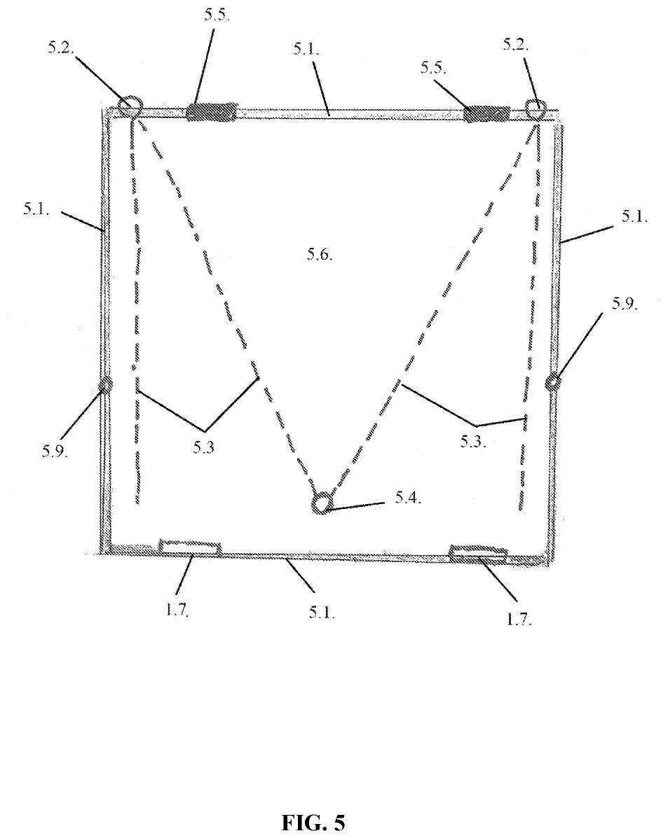

### FIG. 5

[FIG. 5] represent a detail of the canopy,

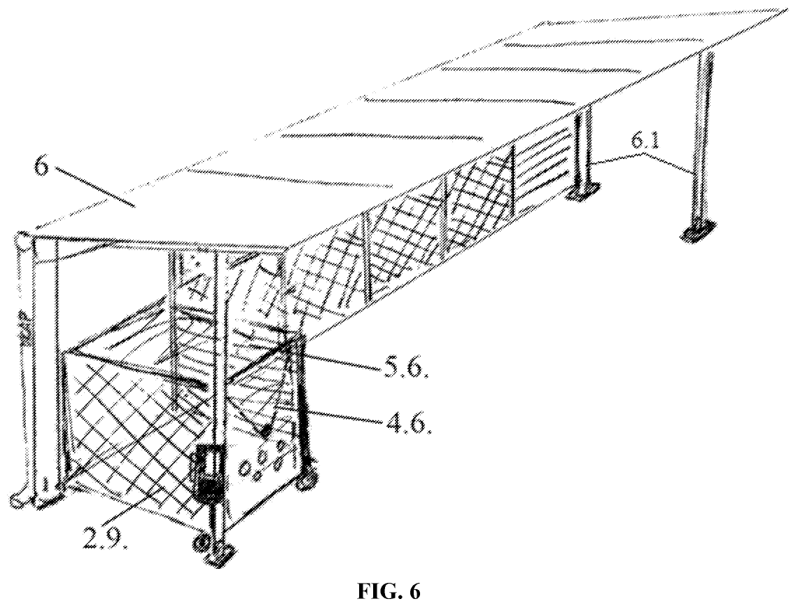

### FIG. 6

[FIG. 6] represent an embodiment of the variable collapsible pen with one row of 6 frames with a total of 6 boxes,

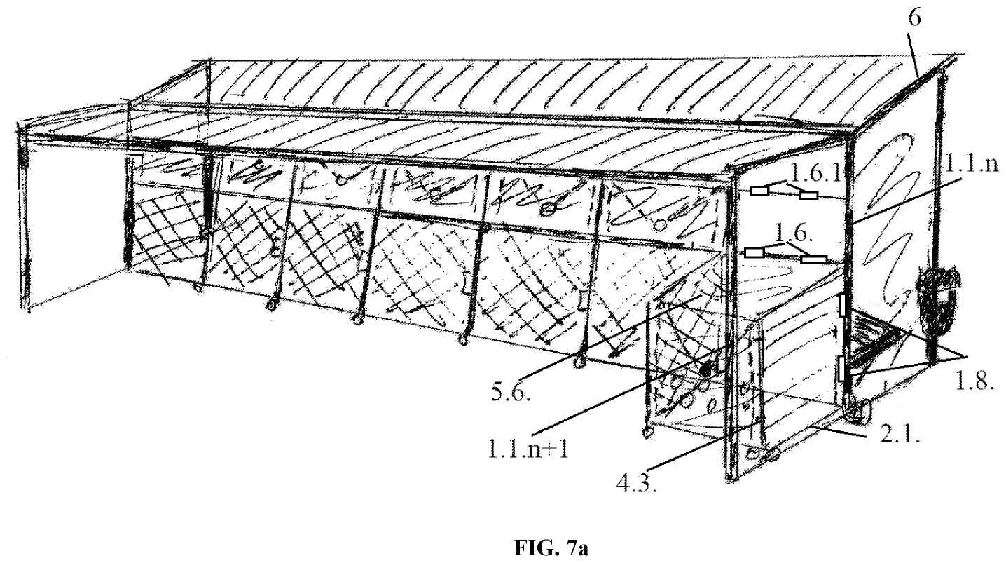

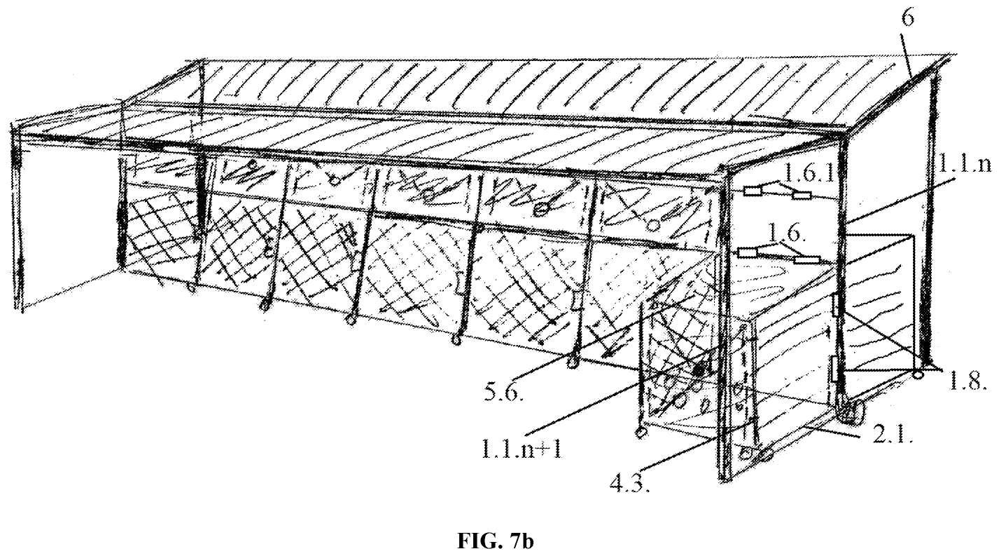

### FIG. 7a

[FIG. 7a] represent a embodiment of the variable folding box/pen with one row of 7 frames provided with a total of 7 boxes and a bench,

### FIG. 7b

[FIG. 7b] represent an embodiment of the variable collapsible pen with two rows of 7 frames provided with a total of 14 boxes,

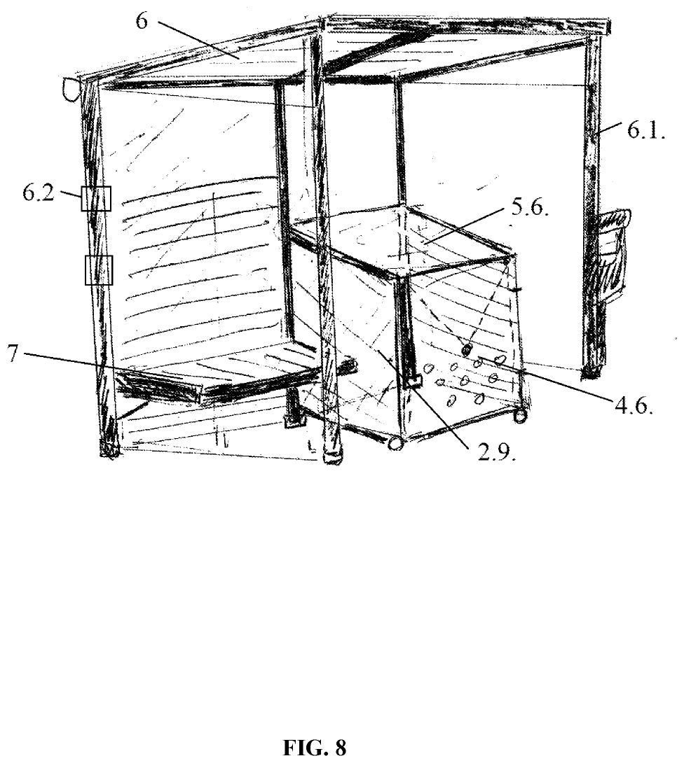

### FIG. 8

[FIG. 8] represent an embodiment of the variable collapsible pen for one dog with a bench,

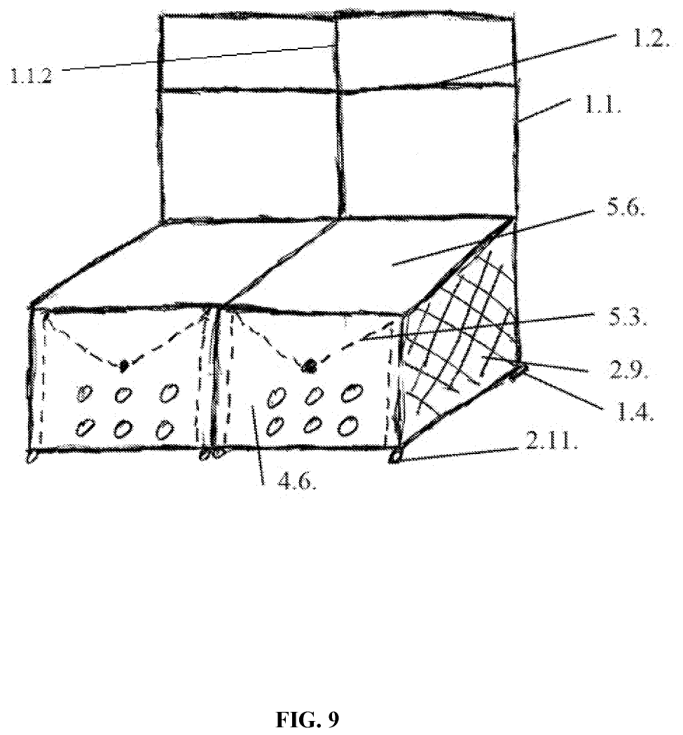

### FIG. 9

[FIG. 9] represent a detail of an embodiment of the variable collapsible pen for 2 dogs,

### Examples

### Example 1

An example embodiment of the variable collapsible pen especially for dogs according to the present invention is illustrated in FIGS. 1 to 6. The variable collapsible pen comprises a row of n equals 6 of rear frames 1 from corrosion-resistant material, provided with backs. Each rear frame 1 comprises two stems, the n-th stem 1.1.n fitted with a foot 1.4 at the bottom with anchoring holes and the (n+1)-th stem 1.1.n+1 fitted with a foot 1.4 at the bottom with anchoring holes, interconnected at least with the top crossbeam 1.2, center crossbeam 1.16 and bottom crossbeam 1.3.

The first stem 1.1.1 is provided in its bottom half under the level of the center crossbeam 1.16 at least on one side with three hinges 1.8 for the outer side panel, with which it is connected to the side panel frame 2.1, filled with an opaque panel 2.9 provided in its bottom third with a horizontal flat bar 2.3 affixed to the side panel frame 2.1 provided with the counterpart 2.10 of the locking mechanism.

The center crossbeam 1.16 is provided with at least two roof hinges 1.7 with which it is connected to the roof frame 5.1 with roof panel 5.6, provided with two locks 5.5 against unintentional folding of the canopy 5, and two first mounts 5.9 of the roof spring which are connected through the roof spring 1.10 with the second mounts 1.9 of the roof spring in the top part of the stem 1.1.n and 1.1.n+1.

The top crossbeam 1.2 is provided with two counterparts 1.6.1 of the lock against unintentional folding of the canopy 5.

The second up to the seventh stems 1.1.2 to 1.1.7 are provided in their bottom half under the level of the center crossbeam 1.16 on one side with three hinges 1.15 of the inner side panel, with which it is connected to the (n-1)-th side panel frame 2.1.1, provided with a lock 1.6 against unintentional opening having an opaque panel 2.9 and which is connected via door hinges 4.7 with the door frame 4.1 with a transparent perforated door panel 4.6 and provided with a door locking mechanism 4.3.

The second up to the seventh outer side panels are provided from the outer side with a horizontal flat bar 2.3 affixed to the inner side panel frame 2.1 and provided with the counterpart 2.10 of the locking mechanism. The roof 6 overlapping the pen is preferably fixed to the stems 1.1.1 to 1.1.7 from above. The roof 6 is additionally supported by pillars 6.1 provided with holders 6.2 for accessories selected from the group of wastebaskets, bags, disposable absorbent floor mats, disposable gloves, disposable cleaning disinfectant wipes, treats, toys, disposable bowls, water barrels.

### EXAMPLE 2

Another example embodiment of the invention is shown in FIG. 9, and the details in FIGS. 1 to 5. The basis of the construction is similar to the previous example. In this embodiment, the variable collapsible pen comprises two rear frames 1 side by side. Stem 1.1.2 is common to both frames. In this variant, the stems are provided with holes 1.5 for attachment to the wall, which also forms the back. The horizontal flat bar 2.3 is provided with mounts 2.2 for the chain 2.4 with snap-ring 2.5 for small dogs up to 35 cm in size, and chain 2.6 with snap-ring 2.7 for medium dogs of size from 35 to 43 cm at withers.

### EXAMPLE 3

Another example embodiment of the invention is shown in FIG. 7a, and the details in FIGS. 1 to 5. The basis of the design is similar to Example 1. In this case, the number of frames n is 7. Each door frame 4.1 is provided with a collapsible handle 4.2 and the inner side frame 2.1.1 is provided on the outside with a collapsible side handle 3.1. The perforation of the transparent breathable door panel 4.6 is implemented by circular ventilation holes 4.5 with a diameter of 2 cm. The inner side panel frame 2.1.1, the outer panel frame 2.1, and the door frame 4.1 on the side away from the rear frame 1 are provided with a castor wheel 2.11. The canopy 5 is provided with an elastic rope 5.3 with a ring 5.4 fixed in the middle for attachment to mount 4.4 of ring 5.4 of the elastic rope 5.3, located on the outer side of panel 4.6 of the door frame 4.1, and fixed with two mounts 5.2 of the elastic rope. The free space under the overhanging roof 6 from the rear side of the variable pen is provided with a bench 7 and a table.

### EXAMPLE 4

Another example embodiment of the invention is shown in FIG. 7b, and the details in FIGS. 1 to 5. It is based on the previous example, the solution is, however, bilateral, meaning that the variable pen is made of two rows of boxes back to back. The first stem 1.1.1 is provided in its bottom half under the level of the center crossbeam on both sides with at least three hinges 1.8 for the outer side panel, with which it is connected to the side panel frame 2.1, and the second up to (n+1)-th stems 1.1.2 to 1.1.n+1 are provided in their bottom half under the level of the center crossbeam on both sides with at least three hinges 1.15 for the inner side panel, with which it is connected to the inner panel frame 2.1.1.

The bottom crossbeam 1.3 is provided on both sides at least with the mount 1.11 of chain 1.12 with snap-ring 1.13 and snap-ring mount 1.14. The chain 1.12 is designated for large dogs of size above 43 cm at withers. The canopy 5 and/or roof 6 are preferably provided with a camera system from the inner side. The roof 6 is additionally provided with a solar panel for the electrical systems like lighting, heating, locking, audio guide. The outer side panel frame 2.1 is provided with a fixed handle 2.8 on the outer side. The outer side panel frame 2.1 is provided with a lock 1.6 against unintentional opening, and the inner side panel frame 2.1.1 is provided with a lock 1.6 against unintentional opening. The locks 1.6 against unintentional opening are provided with magnets. The inner side panel hinges 1.15 and the outer side panel hinges 1.8 have the angle of opening of 90°, and the door hinges 4.7 and the roof hinges 1.7 have the angle of opening of 180°. The transparent panel 4.6 is made of tinted plexiglass, and the clear panel 5.6 is made of polycarbonate with a UV film. The opaque panel 2.9 is made of recycled plastic.

### EXAMPLE 5

Another example embodiment of the invention is shown in FIG. 8, and the details in FIGS. 1 to 5. The design is again based on Example 1. In this case, there is, however, only one pen frame for one dog. On the free space under the roof 6 beside the box itself, a bench 7 is mounted. The transparent panel 4.6 and the clear panel 5.6 are made of clear plexiglass. The opaque panel 2.9 is washable and made of plastic. The pen is provided with a disinfectant coating. The floor in the space for unfolding the pen is provided with an impact rubber plate.

The above examples only illustrate several possible embodiments of the variable folding pen according to the present invention. The final design will always depend on the requirements of the client, it is possible, for example, to use the side panels for commercial or paid advertising, the basic design may be a combination of different colors, while adhering to the principle of the invention. It is clear to the expert skilled in the art that it is possible to replace the elements used by equivalents which fulfill identical functionality and usability of the device.

### INDUSTRIAL APPLICABILITY

The variable collapsible pen especially for dogs according to the present invention can be used especially in all public places where it is not possible to take a dog with you, for example at shops, cemeteries, post offices, parking lots, offices, schools and kindergartens, medical facilities, restaurants, parks, exhibition grounds, playgrounds and sports grounds. It can be used at various rest areas for tourists, motorists, etc.

### REFERENCE SIGNS LIST

1 -rear frame
1.1.n-n-th stem
1.1.n+1 - (n+1)-th stem
1.2-top crossbeam
1.3-bottom crossbeam
1.4-foot
1.5-openings
1.6-side panel lock
1.7-roof hinges
1.8-side panel hinge
1.9 -second spring mounts
1.10-spring
1.11-mount of chain for large dogs
1.12-chain for large dogs
1.13-snap-ring for large dogs
1.14 -mount of snap-ring for large dogs
1.15 -inner side panel hinges
1.16 -center crossbeam
1.6.1 -lock counterpart
2.1 -outer side panel frame
2.1.1 -inner side panel frame
2.2 -chain mount for small dogs
2.3 -horizontal flat bar
2.4 -chain for small dogs
2.5 -snap-ring for small dogs
2.6 -chain for medium dogs
2.7 -snap-ring for medium dogs
2.8 -fixed handle
2.9 -opaque panel
2.10 -counterpart of the side panel locking mechanism
2.11-rotating wheel
3.1 -collapsible side panel handle
4.1 -door frame
4.2 -collapsible door handle
4.3 -door locking mechanism
4.4 -rope ring mount
4.5 -ventilation holes
4.6 -transparent panel
4.7 -door hinges
5 -canopy
5.1 -roof frame
5.2 -elastic rope mount
5.3 -elastic rope
5.4 -rope ring
5.5 -safety against unwanted roof collapsing
5.6 -roof panel
5.9 -first spring mounts
6 -roof
6.1 -pillar
6.2 -accessories holder
7 -bench

What is claimed is:

1. A variable collapsible pen especially for dogs comprises at least n rear frames made of a corrosion-resistant material, where n is greater or equal to 1, provided with a back and formed by stems of corrosion-resistant material interconnected by crossbeams of corrosion-resistant material, characterized in that each rear frame (1) comprises two stems, the n-th stern (1.1.n) fitted with a foot (1.4) at the bottom with anchoring holes and the (n+1)-th stem (1.1.n±1) fitted with a foot (1.4) at the bottom with anchoring holes, interconnected at least with the top crossbeam (1 2), center crossbeam (1.16) and bottom crossbeam (1 3) wherein the first stem (1 1.1) is provided in its bottom half under the level of the center crossbeam (1.16) at least on one side with three hinges (1.8) for the outer side panel, with which it is connected to the outer side panel frame (2.1), filled with an opaque panel (2.9), and provided from its inner side in its bottom third with a horizontal flat bar (2.3) affixed to the outer side panel frame (2.1) provided with the counterpart (2.10) of the locking mechanism, the center crossbeam (1.16) is provided with at least two roof hinges (1.7), with which it is connected to the roof frame (5.1) with a roof panel (5.6), provided with at least two locks (5.5) against unintentional folding of the canopy (5), and at least two first mounts (5.9) of the roof spring (1.10) that are connected through the roof spring (1.10) with the second mounts (1.9) of the roof spring (1.10) in the top part of the stem (1.1.n) and (11.n-1), the top crossbeam (1.2) is provided with two counterparts (1.6.1) of the lock against unintentional folding of the canopy (5) and the second up to the (n+1)-th stem (0.1.2 to 1.1 n) are provided in their bottom balf under the level of the center crossbeam (1.16) at least on one side with at least three hinges (1.15) of the inner side panel, with which it is connected to the (n-1)-th side panel frame (2.1.1), provided with a lock (1.6) against unintentional opening having an opaque panel (2.9) and which is connected via door hinges (4.7) with the door frame (4.1) with a transparent perforated door panel (4.6) and provided with a locking mechanism (4.3), and the second up to the n-th inner side panels are provided from the outer side with a horizontal flat bar (2.3) affixed to the inner side panel frame (2.1) and provided with the counterpart (2.10) of the locking mechanism.

2. The variable collapsible pen especially for dogs according to claim 1, characterized in that the stems are provided with holes (1.5) for mounting on the wall, which at the same time forms the back.

3. The variable collapsible pen especially for dogs according to claim 1, characterized in that the door frame (4.1) is provided with a collapsible door handle (4.2) and the frame (2.1) of the inner side panel is provided with a collapsible side panel handle (3.1) from the outside.

4. (canceled)

5. The variable collapsible pen especially for dogs according to claim 1, characterized in that the inner side panel frame, the outer side panel frame (2.1) and also the door frame (5.1) are provided on the bottom on the side facing away from the rear frame (1) with a castor wheel (2.11).

6. The variable collapsible pen especially for dogs according to claim 1, characterized in that the horizontal flat bar (2.3) is provided with mounts (2.2) for a chain (2.4) with a snap-ring (2.5) for small dogs, and for a chain (2.6) with a snap-ring (2.7) for medium dogs.

7. The variable collapsible pen especially for dogs according to claim 1, characterized in that the canopy (5) is provided with an elastic rope (5.3) with a ring (5.4) fixed in the middle for attachment to mount (4.4) of ring (5.4) of the elastic rope (5.3) located on the outer side of panel (4.6) of the door frame (4.1), and fixed with two mounts (5.2).

8. The variable collapsible pen especially for dogs according to claim 1, characterized in that the first stem (1.1.1) is provided in its bottom half under the level of the center crossbeam (1.16) on both sides with at least three hinges (1.8) for the outer side panel, with which it is connected to the side panel frame (2.1), and the second up to the (n+1)-th stem (1.1.2 to 1.1.n+1) are provided in their bottom half under the level of the center crossbeam (1.16) on both sides with at least three hinges (1.1 5) for the inner side panel, with which it is connected to the (n-1)-th inner panel frame (2.1.1).

9. The variable collapsible pen especially for dogs according to claim 1, characterized in that the bottom crossbeam (1.3) is provided at least on one side with one mount (1 11) of a chain (1 12) with a snap-ring (1.13), and a mount for a snap-ring (1.14) for large dogs.

10. The variable collapsible pen especially for dogs according to claim 1, characterized in that on the stems (1 1.1 to 1.1.n+1), the roof (6) is fixed from above, which overhangs the pen.

11. The variable collapsible pen especially for dogs according to claim 10, characterized in that the roof (6) is additionally supported by pillars (6.1) provided with holders (6.2) for accessories selected from the group of wastebaskets, bags, disposable absorbent floor mats, disposable gloves, disposable cleaning disinfectant wipes, treats, toys, disposable bowls, water barrels.

12. The variable collapsible pen especially for dogs according to claim 10, characterized in that the space under the overhanging roof (6) beside the pen is provided with a bench (7) and/or a table.

13. The variable collapsible pen especially for dogs according to claim 10, characterized in that the canopy (5) and/or roof (6) are provided with a camera system on the inner side.

14. The variable collapsible pen especially for dogs according to claim 10, characterized in that the roof (6) and/or canopy (5) are provided with a solar panel for electrical system selected from the group of: lighting, heating, locking, audio guide, software-controlled actuator for both folding and unfolding, and software-controlled controller for use of the variable collapsible pen.

15. The variable collapsible pen especially for dogs according to claim 1, characterized in that the frame (2.1) of the outer side panel is provided with a fixed handle (2.8) on the outside.

16. The variable collapsible pen especially for dogs according to claim 1, characterized in that the frame (2.1) of the outer side panel is provided with a lock (1.6) against unintentional opening, and the inner side panel frame (2.1 1) is provided with a lock (1.6) against unintentional opening.

17. The variable collapsible pen especially for dogs according to claim 1, characterized in that the locks (1.6) against unintentional opening are provided with magnets.

18. The variable collapsible pen especially for dogs according to claim 1, characterized in that the inner side panel hinge (1.15) and the outer side panel hinge (1.8) have the angle of opening of 90°, and the door hinge (4.7) and the roof hinge (1.7) have the angle of opening of 180°.

19. The variable collapsible pen especially for dogs according to claim 1, characterized in that the floor in the space for unfolding the pen is provided with an impact rubber plate.

20. The variable collapsible pen especially for dogs according to claim 1, characterized in that the transparent panel (4.6) and clear panel (5.6) are made of materials selected from the group of clear plexiglass, tinted plexiglass, polycarbonate with a UV film.

21. The variable collapsible pen especially for dogs according to claim 1, characterized in that the opaque panel (2.9) is washable and selected from the group of plastic, recycled plastic.

22. (canceled)
